(19) United States
(12) Patent Application Publication
(10) Pub. No.: US 2015/0278267 A1
(43) Pub. Date: Oct. 1, 2015

(54) PROCESSING METHOD AND INFORMATION PROCESSING APPARATUS

(71) Applicant: FUJITSU LIMITED, Kawasaki-shi (JP)

(72) Inventor: Tomoaki Sato, Yotukaido (JP)

(21) Appl. No.: 14/668,614

(22) Filed: Mar. 25, 2015

(30) Foreign Application Priority Data
Mar. 27, 2014 (JP) 2014-065792

(51) Int. Cl. G06F 17/30

(52) U.S. Cl. CPC G06F 17/30321; G06F 17/30595

(57) ABSTRACT

A processing method includes storing a sheet including rows and a definition body, each of the rows including a plurality of elements corresponding to elements of a plurality of tables, and the definition body including key elements in each of the plurality of tables and relation with an element in other tables, and generating, with respect to each of the rows, a key corresponding to each of the plurality of tables and relation of a key with an element in other tables based on the definition body.

### CROSS-REFERENCE TO RELATED APPLICATION

This application is based upon and claims the benefit of priority of the prior Japanese Patent Application No. 2014-065792, filed on Mar. 27, 2014, the entire contents of which are incorporated herein by reference.

### FIELD

Disclosure relates to a processing method and an information processing apparatus.

### BACKGROUND

There is an RDB (Relational Database) system as a management method for storage of data processed in an information processing system, and so on. In the RDB, for example, a piece of data is expressed as a set of plurality of items (for example, field). A set of data is expressed in a tabular form called a table. The information processing system performs normalization of a table in order to remove data redundancy and secure extendibility when the RDB is adopted.

For more information, see Japanese Laid-Open Patent Publication No. 2005-196589, Japanese Laid-Open Patent Publication No. 10-334162, Japanese Laid-Open Patent Publication No. 08-235285, and Japanese Laid-Open Patent Publication No. 2002-197405.

In a case where the RDB is adopted, for example, in a case where a large amount of data is manually registered in a database, there is a problem in an interface that enables registration/update of data in a state where consistency between data to extend over a plurality of tables is secured without noticing association of data items.

For example, there is a tool that automatically creates an input screen as an interface with respect to a single table. However, in a case where information processing systems that treat a record including data registered in a plurality of tables are developed, an input screen of an interface related to data inputting is individually developed for each of the information processing systems.

### SUMMARY

One of embodiments of the invention is a computer-readable recording medium having stored therein a program for causing a computer to execute a process comprising storing a sheet including rows and a definition body, each of the rows including a plurality of elements corresponding to elements of a plurality of tables, and the definition body including key elements in each of the plurality of tables and relation with an element in other tables, and generating, with respect to each of the rows, a key corresponding to each of the plurality of tables and relation of a key with the element in other tables based on the definition body.

The target and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram that describes an information processing system;

FIG. 2 is a diagram illustrating a hardware configuration example of an information processing apparatus;

FIG. 3A is an explanatory diagram that describes a worksheet having a definition region and an input region;

FIG. 3B is an explanatory diagram that describes the relation with other tables;

FIG. 3C is a diagram illustrating a table example in which data of an input region is registered in multiple tables according to a definition region;

FIG. 4A is an explanatory diagram that describes data update processing with respect to a DB;

FIG. 4B is an explanatory diagram that describes data update processing with respect to a DB;

FIG. 4C is an explanatory diagram that describes data update processing with respect to a DB;

FIG. 4D is an explanatory diagram that describes data update processing with respect to a DB;

FIG. 5A is a flowchart exemplifying registration processing with respect to a DB;

FIG. 5B is exemplification of a flowchart of registration processing in S4 exemplified in FIG. 5A; and

FIG. 5C is exemplification of a flowchart of registration processing in S4 exemplified in FIG. 5A.

### DESCRIPTION OF EMBODIMENTS

In the following, an information processing apparatus according to an embodiment is described with reference to the drawings. The configuration of the following embodiment is exemplification, and the information processing apparatus is not limited to the configuration of the embodiment.

### EXAMPLE

### [System Configuration]

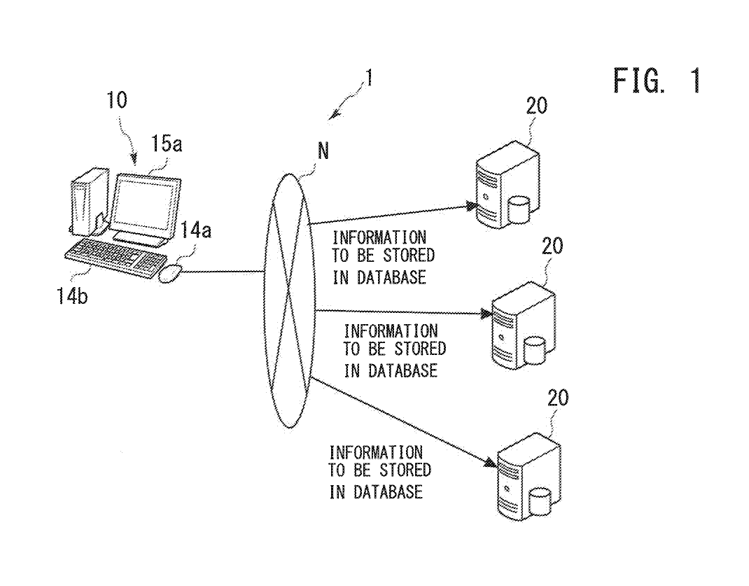

FIG. 1 is an explanatory diagram of an information processing system 1 of the present embodiment. The information processing system 1 includes an information processing apparatus 10 and a plurality of storage apparatuses 20 that are connected through network N. For example, the network N includes a public network such as the Internet, and a wireless network such as a mobile phone network. Each of the plurality of storage apparatuses 20 may be connected with the network N.

In the information processing system 1, for example, the information processing apparatus 10 is a computer such as a server or a Personal Computer (PC). The storage apparatus 20 is a storage apparatus including a storage medium that stores various kinds or types of programs and various kinds or types of data. The storage apparatus 20 is also called an external storage apparatus. As the storage medium included in the storage apparatus 20, for example, at least one of a solid-state drive (SSD) apparatus and a hard disc drive (HDD) apparatus, and so on, is applied. Moreover, the storage apparatus 20 may include a removable recording medium such as a Compact Disc (CD) drive device, a Digital Versatile Disc (DVD) drive device and a BD (Blu-ray Disc) drive device. Here, for example, the information processing apparatus 10 and the storage apparatus 20 may be formed as a part of a “cloud” that is a computer group on a network.

In the information processing system 1, the information processing apparatus 10 manages data processed in the information processing system 1 by an RDB (Relational Database) system and stores the data in the database of each of the storage apparatuses 20. In the RDB system, a piece of data is expressed as a set of a plurality of items (for example, “field”), and a set of data is expressed in a format called “table”. Each item of each table becomes a target for various kinds of processing and/or management performed in the information processing system 1 by operation with the items of other tables. The information processing apparatus 10 normalizes a plurality of tables that each item is associated with each other. The normalized tables are stored in each of the storage apparatuses 20 as a database.

The information processing system 1 accepts data inputted by an operator, and so on. The information processing system 1 secures the consistency and relation of inputted data to register data in a plurality of tables and performs data management in the RDB. In the information processing system 1, a model of data registered in the database is defined as a worksheet having a table format. The worksheet has a definition region that attributes of a plurality of tables and columns of a database of data registration destination, and the relationship between tables is defined. The worksheet has an input region to input data. For example, the definition region is located in a head part of the worksheet and the input region is set following the definition region.

In the information processing system 1, the information processing apparatus 10 analyzes the definition region located in the head part of the worksheet to specify the relationship between a plurality of tables that become input destinations. The information processing apparatus 10 performs association of data inputted in the input region of the worksheet, based on the relationship among the plurality of tables. The associated data are collectively registered and updated to a database corresponding to the plurality of tables defined in the worksheet. As the database corresponding to the plurality of tables that become the registration destinations of data may be, for example, a single database including the plurality of tables. As the database, a plurality of databases that separately manage the plurality of tables maybe applied. That is, there is no limitation in the database configuration in the present embodiment.

In the information processing system 1, it is possible to collectively register and update data inputted in the input region of the worksheet, to each table. At this time, the relation between data to extend over the plurality of tables that become the registration destinations is maintained. As a result, according to the information processing system 1, it is possible to perform collective registration and update to the database in a state where the consistency between data is secured.

### [Device Configuration]

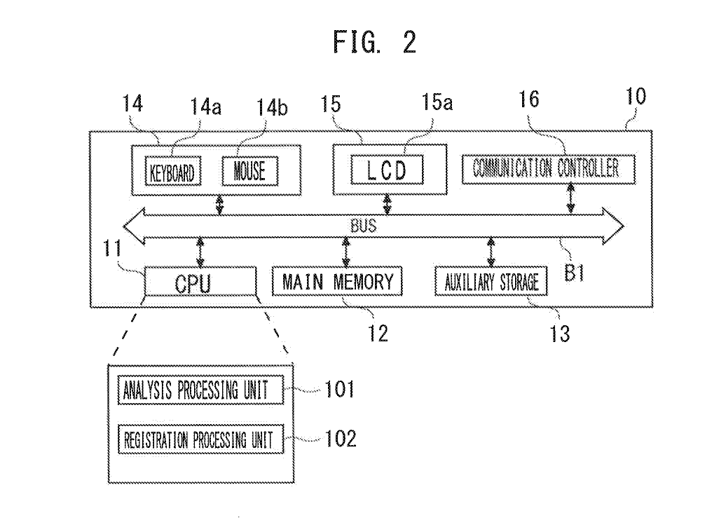

FIG. 2 illustrates an example of a hardware configuration the information processing apparatus 10. The information processing apparatus 10 exemplified in FIG. 2 has the configuration of a general computer. The information processing apparatus 10 includes a Central Processing Unit (CPU) 11, a main storage device (main memory) 12, an auxiliary storage device (auxiliary storage) 13, an input device 14, an output device 15 and a communication controller 16 that are mutually connected by a bus B1.

Each of the main memory device 12 and the auxiliary storage device 13 is an example of a computer readable medium used by the information processing apparatus 10.

In the information processing apparatus 10, the CPU 11 loads each program stored in the auxiliary storage device 13 on a work region of the main storage device 12 to execute the program. The CPU 11 controls peripheral equipment through the execution of the program. By the execution of the program, the information processing apparatus 10 may achieve functions that correspond to predetermined objects.

In the information processing apparatus 10 exemplified in FIG. 2, the CPU 11 controls a whole of the information processing apparatus 10. The CPU 11 performs processing according to the program stored in the auxiliary storage device 13. The main storage device 12 is a storage medium used as an area that the CPU 11 caches a program and data. The main storage device 12 is used as a work area of the CPU 11. For example, the main storage device 12 includes a Random Access Memory (RAM). The main storage device may include a RAM and a Read Only Memory (ROM).

The auxiliary storage device 13 stores various kinds of programs and various kinds of data in a recording medium in a readable and writable manner. An operating system (OS), various kinds of programs and various kinds of tables, and so on are stored in the auxiliary storage device 13. The OS includes a communication interface program to transmit/receive data to/from external apparatuses connected via the communication controller 16. The external apparatuses may include, for example, an information processing apparatus such as other servers, an external storage apparatus and an apparatus having a communication function, on the network N.

For example, the auxiliary storage device 13 may be at least one of an Erasable Programmable ROM (EPROM), a solid-state drive (SSD) device and an Hard Disc Drive (HDD) device, and so on. Moreover, as the auxiliary storage device 13 may include a CD drive device, a DVD drive device and a BD drive device, and the like. As an example of a recording medium, for example, there are a silicon disc including a nonvolatile semiconductor memory, a flash memory, a hard disc, a CD, a DVD, a BD, a Universal Serial Bus (USB) memory and a memory card, and so on.

The input device 14 accepts an operation instruction, and so on, from users or operators. The input device 14 may include at least one of a button, a keyboard 14a, a pointing device such as a mouse 14b and a touch panel, and an input device such as a wireless remote controller, a microphone and a camera. The CPU 11 receives data inputted from the input device 14 through the bus B1.

The output device 15 outputs data and information. For example, the output device outputs data to be processed by the CPU 11, results of processing by the CPU 11 and data to be stored in the main storage device 12, and so on. The output device 15 is, for example, at least one of output devices such as a Cathode Ray Tube (CRT) display, a Liquid Crystal Display (LCD) 15a, a Plasma Display Panel (PDP), an Electroluminescence (EL) panel, and an organic EL panel. The output device may further include at least one of a printer and a speaker. The communication controller 16 is, for example, an interface with network N. One of a local area network card (LAN card) and a network interface card (NIC) maybe applied as the communication controller 16.

In the information processing apparatus 10, the CPU 11 executes the OS and various kinds of programs (application programs). By the execution of the programs, the CPU 11 may operate as an analysis processing unit 101 and a registration processing unit 102. Moreover, the auxiliary storage device 13 of the information processing apparatus 10 holds data which the CPU 11 refers to or manages.

By the program execution of the CPU 11, the information processing apparatus 10 analyzes the definition region of the worksheet and generates an internal object with respect to the plurality of tables corresponding to data registration destinations. Here, the internal object is an interface to the plurality of tables defined by the worksheet. Various kinds of data described in the record of the input region of the worksheet are processed based on the internal object.

The internal object includes a plurality of table objects defined in the worksheet, column information included in each table object, and the relation between respective table objects, and so on. Here, the table object is the interface of each table defined in the worksheet. Data described in the input region of the worksheet are processed according to the table object.

Moreover, the information processing apparatus 10 registers data inputted in a record in the input region of the worksheet in the plurality of tables based on the generated internal object. The information processing apparatus 10 divides the records of the input region of the worksheet into the regions of respective table objects as mentioned above. The information processing apparatus 10 associates data included in the divided regions with the column regions of respective table objects. Regarding the data included in the divided regions, the information processing apparatus 10 performs association between the table objects according to the definition of relation between the table objects. The information processing apparatus 10 may collectively register and update the data inputted in the record of the input region of the worksheet to the plurality of tables.

The analysis processing unit 101 of the information processing apparatus 10 accepts the worksheet in which data are inputted. With respect to the head part of the worksheet, the analysis processing unit 101 analyzes the definition region corresponding to the items of the worksheet. The analysis processing unit 101 generates internal objects corresponding to the plurality of tables. For example, the analysis processing unit 101 generates table objects corresponding to the plurality of tables defined in the worksheet, and records column information in each of the table objects. The analysis processing unit 101 generates the relation between respective table objects. For example, the generated internal objects are temporarily stored in a predetermined region of the main storage device 12 and delivered to the registration processing unit 102.

The registration processing unit 102 of the information processing apparatus 10 divides the records of the input region of the worksheet in units of tables based on the internal objects generated in the analysis processing unit 101. The registration processing unit 102 registers and updates the data of the record divided in units of tables to items corresponding to respective tables (hereinafter, the items may be called columns) . The data inputted in the record of the input region of the worksheet are collectively registered and updated to the plurality of tables based on the internal objects generated in the analysis processing unit 101.

One of the analysis processing unit 101 and the registration processing unit 102 may be executed in other information processing apparatuses. For example, by connecting an information processing apparatus including the analysis processing unit 101 and an information processing apparatus including the registration processing unit 102 through network N, the analysis processing unit 101 and the registration processing unit 102 may perform operations as the information processing apparatus 10. By separately disposing the analysis processing unit 101 and the registration processing unit 102 in a plurality of information processing apparatuses, it is possible to reduce the processing load of each of the information processing apparatuses.

### [Data Processing Example by Worksheet]

### (DB Registration)

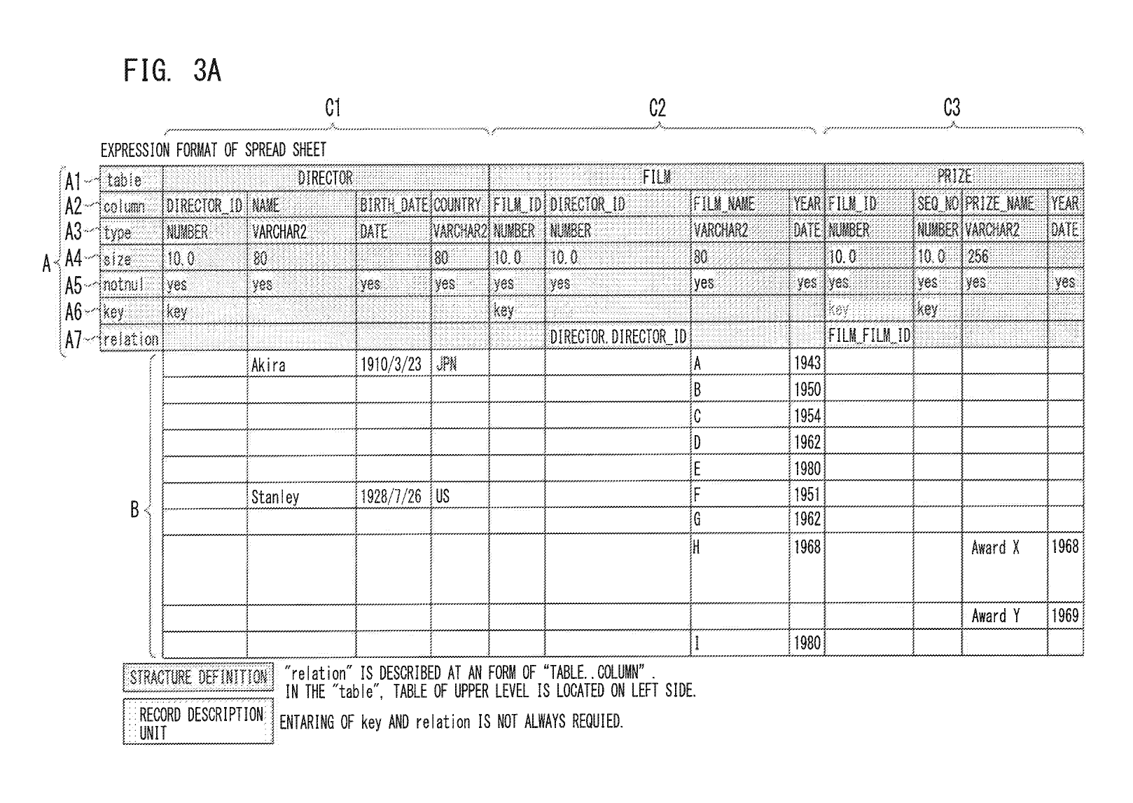

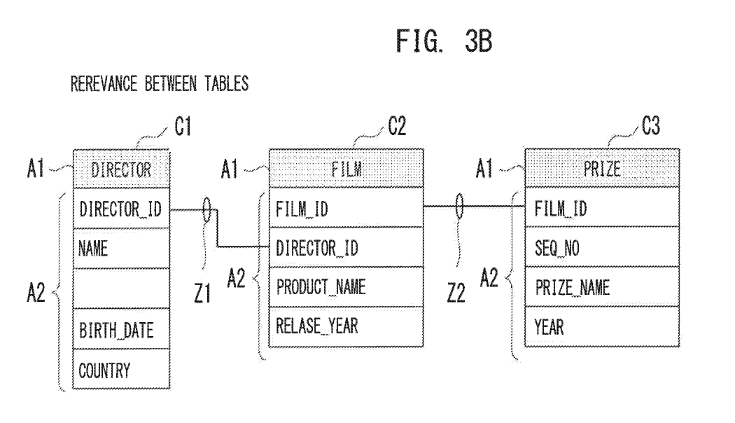

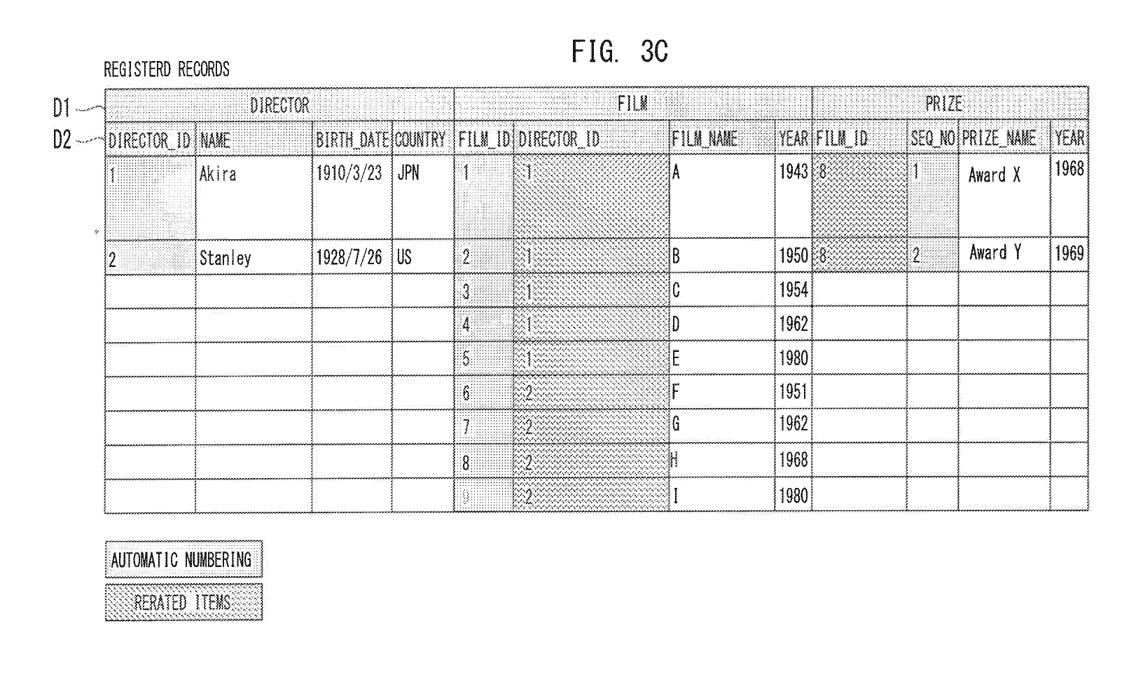

Next, a data processing example using the worksheet in the information processing apparatus 10 is described with reference to FIGS. 3A, 3B and 3C. FIG. 3A illustrates an example of a worksheet expressed a table format. The worksheet includes a definition region and the input region. The definition region is a region or area to store definition information indicating definitions of tables and attributes of columns being operation targets of a database and relations between the tables. The input region is a region or area to store data inputted into the worksheet. For example, the worksheet illustrated in FIG. 3A may be a spreadsheet having a table format such as MS-EXCEL (R) of Microsoft Corporation.

In the following explanation, a row of a definition region of the worksheet is called “definition record”, and a column defined by information stored in the definition region is called “column”. Moreover, a row of the input region B is called “record”. The “record” of the input region B is divided, in the vertical direction, into a plurality of regions or areas (fields), each of which corresponds to one of the “columns”.

The worksheet exemplified in FIG. 3A includes the definition region A and the input region B. The definition region A is located on an upper portion of the worksheet. The input region B is located under the definition region A. The definition region A is formed by one or more rows each of which stores a definition record. Each of the definition records stores information indicating a table structure. Moreover, the definition region A and the input region B are divided, in the vertical direction, into table regions corresponding to tables created on the worksheet. In the example of FIG. 3A, the definition region A and the input region B is divided into table regions to form tables C1, C2 and C3. Each of the table regions is further divided into column regions corresponding to information items (column items) stored in each table. In other words, each of the tables C1, C2 and C3 has a plurality of columns.

The input region B has one or more rows. Each of rows of the input region B is used as a record region to store input data. As described above, the input region B is divided into the plurality of table regions each of which includes the column regions (input area ranges) corresponding to one of the table C1, C2 and C3. Hereinafter, the row of the definition region A may be referred to as a record or a record region of the definition region A. The row of the input region B may be referred to as a record or a record region of the input region B. Each of the records of the input region B stores data inputted to the information processing apparatus 10.

In the worksheet exemplified in FIG. 3A, the definition region A includes a plurality of definition records A1 to A7. The definition records A1 to A7 stores information for defining a table structure. The definition record A1 includes an item “table”, and the definition record A2 includes an item “column”. The definition record A3 includes an item “type”, and the definition record A4 includes an item “size”. The definition record A5 includes an item “notnul”, the definition record A6 stores an item “key”, and the definition record A7 includes an item “relation”.

The definition information “table” of the definition record A1 defines tables in which relation between the tables is formed by processing of the worksheet. The definition record A1 stores information indicating the tables related each other. The information indicating the table uniquely identifies each table. For example, the information indicating the table is identification information (identifier) or name of the table. The record region (row) of the definition record A1 is divided into a column regions corresponding to each of the tables C1, C2 and C3. Each of the column regions of the definition record A1 stores the information indicating the table (a table name) corresponding table (one of the tables C1, C2 and C3).

The definition information “column” of the definition record A2 defines information indicating items (classes or types) of columns in each of the tables C1, C2 and C3. The record region (row) of the definition record A2 is divided into a plurality of column regions corresponding to column items (information items) defined with respect to each of the tables C1, C2 and C3. Each of the column regions of the definition record A2 stores the information indicating items of each column.

The definition information “type” of the definition record A3 defines information indicating an input form of data corresponding to each column item. The input form may include at least number, varchar and date. The record region (row) of the definition record A3 is divided into a plurality of column regions corresponding to column items of each of the tables C1, C2 and C3. Each of the column regions of the definition record A3 stores the information indicating the input form of corresponding column item.

The definition information “size” of the definition record A4 defines information indicating a size of data corresponding to each column item. The record region (row) of the definition record A4 is divided into a plurality of column regions corresponding to column items of each of the tables C1, C2 and C3. Each of the column regions of the definition record A4 stores the information indicating the data size of each column item.

The definition information “notnul” of the definition record A5 defines information (“notnul” information) indicating whether a state that data is not entered is allowed or not with respect to each column item. For example, the information indicating whether a state that data is not entered is allowed or not with respect to each column item may be expressed by a binary status such as “yes” and “no”. The record region (row) of the definition record A5 is divided into a plurality of column regions corresponding to column items of each of the tables C1, C2 and C3. Each of the column regions of the definition record A5 stores the binary status of each column item.

The definition information “key” of the definition record A6 defines information (key element information) indicating whether the column item is a key element or not. In data management using the RDB system, automatic numbering and normalization are performed based on the column item related to the key element. For example, the information indicating whether the column item is a key element or not is a character string (e.g., “key”) or sign indicating that the column item is a key element. The record region (row) of the definition record A6 is divided into column regions corresponding to column items of each of the table C1, C2 and C3. The column regions of the definition record A6 may store the information indicating whether the column item is a key element or not.

The definition information “relation” of the definition record A7 defines information (relation information) indicating relation (or relevance) to extend over multiple tables, for every column item. For example, the information indicating the relation to extend over multiple tables may be expressed by a pair of a table name of a relation source and a column item of the relation source. For example, the pair is expressed by a form of “(table). . . (column)”. The record region (row) of the definition record A7 is divided into a plurality of column regions corresponding to column items of each of the table C1, C2 and C3. The column regions of the definition record A6 may store the relation with other tables.

Here, in the worksheet exemplified in FIG. 3A, the number of definition records of the definition region A is not limited. For example, the number of definition records in definition region A may be changed according to an information processing system in which data management based on the RDB system is performed, a table structure, and so on. A worksheet including the definition region A includes at least information indicating a plurality of tables included in the worksheet, column information becoming a numbering target when normalization is performed, and a definition record corresponding to information indicating the relation of data between the tables.

In the example of FIG. 3A, The table C1, C2 and C3 is formed by division of the definition region A and the input region B. The table C1 has a table name “DIRECTOR”, the table C2 has a table name “FILM”, and the table C3 has a table name “PRIZE”.

The definition record A1 includes regions (areas) corresponding to the table regions (the tables C1, C2 and C3). Each of the regions stores the table name of corresponding table (one of “DIRECTOR”, “FILM” and “PRIZE”). The table C1 having the table name “DIRECTOR” (the “DIRECTOR” table C1) is a table to store information relating to movie directors. The table C2 having the table name “FILM” (the “FILM” table C2) is a table to store information relating to works created by the movie directors. The table C3 having the table name “PRIZE” (the “PRIZE” table C3) is a table to store information relating to prizes and awards with respect to the works.

The definition record A2 includes column regions corresponding to column items (information items) defined with respect to each of the tables C1, C2 and C3. For example, in the “DIRECTOR” table C1, the definition record A2 is divided into column regions “DIRECTOR_ID”, “NAME”, “BIRTH_DATE” and “COUNTRY”. The “DIRECTOR_ID” is a column item of a column (“DIRECTOR_ID” column) in which identification information uniquely identifying a movie director is inputted as input data. The “NAME” is a column item of a column (“NAME” column) in which a name of the movie director is inputted as input data. The “BIRTH_DATE” is a column item of a column (“BIRTH_DATE” column) in which the date of birth of the movie director is inputted as data. The “COUNTRY” is a column item of a column (“COUNTRY” column) in which the nationality of the movie director is inputted as data.

In the “FILM” table C2, the definition record A2 is divided into column regions “FILM_ID”, “DIRECTOR_ID”, “FILM_NAME”, and “YEAR”. The “FILM_ID” is a column item of a column (“FILM_ID” column) in which identification information uniquely identifying a movie work is inputted as input data. The “DIRECTOR_ID” is a column item of a column (“DIRECTOR_ID” column) in which identification information of a movie director is inputted as input data. The “FILM_NAME” is a column item of a column (“FILM_NAME” column) in which a title of the movie work is inputted as input data. The “YEAR” is a column item of a column (“YEAR” column) in which the publication year of the movie work is inputted as input data. Data inputted into the “DIRECTOR_ID” column of table C1 is described in the “DIRECTOR_ID” column of the table C2.

Moreover, in the “PRIZE” table C3, the definition record A2 is divided into column regions “FILM_ID”, “SEQ_NO”, “PRIZE_NAME” and “YEAR”. The “FILM_ID” is a column item of a column (“FILM_ID” column) in which identification information of a movie work is inputted as input data. The “SEQ_NO” is a column item of a column (“SEQ_NO” column) in which identification information uniquely identifying prizes or awards given to the movie work or the movie director is inputted as input data. The “PRIZE_NAME” is a column item of a column (“PRIZE_NAME” column) in which a name of prizes or awards is inputted as input data. The “YEAR” is a column item of a column (“YEAR” column) in which the reception year of the prizes or awards is inputted as input data. Data inputted in the “FILM_ID” column of the table C2 is described in the “FILM_ID” column of the table C3.

The definition record A3 of each of the tables C1, C2 and C3 stores information indicating a data format such as “NUMBER”, “VARCHAR2” and “DATE”. The definition record A4 stores information indicating the size data size such as “10.0”, “80” and “256” with respect to the tables C1, C2 and C3. Each of the column regions of the definition record A5 stores “notnul” information (the character storing “yes”) with respect to the tables C1, C2 and C3.

In the definition record A6, key element information (“key”) is stored in the column region of the “DIRECTOR_ID” in the table C1, the column region of the “FILM_ID” in the table C2, the column regions of the “FILM_ID” and the “SEQ_NO” in the table C3. All of the column region of the “DIRECTOR_ID” in the table C1, the column region of the “FILM_ID” in the table C2 and the column region of the “FILM_ID” in the table C3 are located in the left ends of respective table regions.

The identification numbers allocated by automatic numbering are inputted in the columns defined as key elements. In respective table regions, as illustrated in FIG. 3A, the column defined as key elements are disposed in the left ends of each of the table regions. Thereby, it is possible to achieve normalization of the tables at data processing.

The definition record A7 stores information indicating the relation between tables. In the example of FIG. 3A, the column region of the definition record A7 corresponding to the “DIRECTOR_ID” column in the table stores the information indicating the relation between the table C1 and the table C2. The column region of the definition record A7 corresponding to the “FILM_ID” column in the table C3 stores the information indicating relation between the table C2 and the table C3. The “FILM_ID” column in the table C3 includes the key element information and the relation information. When the key element information overlaps the relation information, the relation information is prioritized. By prioritizing the relation information, the consistency between data to extend over multiple tables is secured.

In addition, when the key element information overlaps with the relation information, for example, another column defined as a key element is disposed on a location adjacent to the column in which the definition information overlaps. In the example of the table C3 of FIG. 3A, the “SEQ_NO” column, which has definition as a key element, is disposed on the right side of the “FILM_ID” column. Thus, by disposing another column of a key element on an adjacent column region for a column in which the key element information and the relation information overlaps, automatic numbering based on another column is enable while securing the consistency between data to extend over multiple tables. As a result, it becomes possible to perform automatic numbering for each input data on data input in a column region corresponding to the column in which the relation with other tables is defined, and generate a normalized table.

In the definition the record A7 exemplified in FIG. 3A, the relation information indicating the relation to extend over tables is stored in a column region at a form “(table) . . . (column)”. The “(table)” includes the information indicating a table defined by the definition record A1. On the other hand, the “(column)” includes the information indicating a column item defined by the definition record A2.

For example, the relation information “DERECTOR . . . DERECTOR_ID” is stored in the column region of the definition record A7 corresponding to the “DIRECTOR_ID” column in the table C2. For example, the relation information “DERECTOR . . . DERECTOR_ID” in the table C2 indicates that the column “DIRECTOR_ID” in the table C2 (“FILM” table) and the column “DIRECTOR_ID” in the table C1 (“DIRECTOR” table) have relation.

Moreover, for example, the relation information “FILM . . . FILM_ID” is stored in the column region corresponding to the column “FILM_ID” in the table C3. The relation information “FILM . . . FILM_ID” in the table C3 indicates that the column “FILM_ID” in the table C3 (“PRIZE” table) and the column “FILM_ID” in the table C2 (“FILM” table) have relation.

FIG. 3B exemplifies an explanatory diagram illustrating the relation between tables defined in the definition record A7. In the explanatory diagram of FIG. 3B, the “DIRECTOR” table C1, the “FILM” table C2 and the “PRIZE” table C3 included in the worksheet are depicted. Moreover, as defined in the definition record A2, the “DIRECTOR” table C1 includes the columns “DIRECTOR_ID”, “NAME”, “BIRTH_DATE” and “COUNTRY”. Similarly, the “FILM” table C2 includes the columns “FILM_ID”, “DIRECTOR_ID”, “FILM_NAME” and “YEAR”. The “PRIZE” table C3 includes the columns “FILM_ID”, “SEQ_NO”, “PRIZE_NAME” and “YEAR”.

In the explanatory diagram of FIG. 3B, column items forming the relation between tables are mutually connected by connection lines Z1 and Z2. For example, the column item “DIRECTOR_ID” in the “FILM” table C2 has relation with the column item “DIRECTOR_ID” in the “DIRECTOR” table C1. Therefore, both of the column items “DIRECTOR_ID” are connected by the connection line Z1. Moreover, the column item “FILM_ID” in the “PRIZE” table C3 has relation with the column item “FILM_ID” in the “FILM” table C2. Therefore, both of the column items “FILM_ID” are connected by the connection line Z2.

As exemplified in FIG. 3B, in the definition record A7, a table name and a column item of a relation source are combined in a pair format and are stored in a column region of the definition record A7 in a relation destination table. For example, a pair of the table name “DERECTOR” and the column item “DERECTOR_ID” of the table C1 being the relation source table is stored in the definition record A7 of the table C2 being the relation destination table. Hence, it is possible to specify information of the relation source in processing with respect to data inputted in the table of the relation destination, and to perform data processing based on the information of the relation source. Therefore, it is possible to secure the consistency between data to extend over multiple tables.

As exemplified in FIG. 3B, the tables C1, C2 and C3 are layered. The “DERECTOR” table C1 is located on the highest order. The “FILM” table C2 is located on the second order. The “PRIZE” table C3 is located on the third order. In the worksheet example of FIG. 3A, the tables C1, C2 and C3 are arranged in order of the table C1, the table C2 and the table C3 from the left side. Thus, the table regions (the tables C1, C2 and C3) on the worksheet are arranged in the layer order from the highest order and from the left side. Therefore, collective data registration to the RDB having a layered table structure becomes possible.

Returning to the explanatory diagram of FIG. 3A, in the worksheet, for example, data input with respect to the input region B is performed based on information defined in the definition records A1 to A7. For example, the data input with respect to the input region B is performed in each record of the input region B of the worksheet. The data input with respect to the input region B may be manually performed by an operator. Alternatively, for example, data is received from the network N may be automatically inputted. The data inputted to the input region B may be data measured by one or more measuring instruments.

In a case where data input is manually performed by the operator, for example, the definition region A may be subjected to lock processing such as cell protection. Moreover, for example, the definition records A3 to A7 excluding the definition records A1 and A2 and definition records indicating the column items of respective tables may be non-displayed. By causing the definition records A3 to A7 to enter a non-display state, it is possible to prevent falsification by the third person and unrequested data input due to wrong operation by an operator.

In the records of the input region B, for example, it is possible to omit the data input with respect to the column regions corresponding to the column item of the key elements defined in the definition record A6 and the column item having relation with another table defined in the definition record A7. Here, in a case where the data input is manually performed by the operator, cell protection or non-display processing may be applied to the column items defined in the definition records A6 and A7. By applying cell protection or non-display processing to the column items defined in the definition records A6 and A7, for example, it is possible to prevent unintended data input due to wrong operation by the operator.

As illustrated in the example of FIG. 3A, in a row of the input region B in the table C1, a name “Akira”, a date “1910/3/23” and a country “JPN” is stored (inputted) as a record. The name “Akira” is inputted in the “NAME” column of the table C1, the date “1910/3/23” is inputted in the “BIRTH_DATE” column of the table C1 and the country “JPN” is inputted in the “COUNTRY” column of the table C1. Moreover, one of remaining rows of the input region B in the table C1, a name “Stanley”, a date “1928/7/26” and a country “US” are stored (inputted) as another record. The name “Stanley” is stored in the “NAME” column, the date “1928/7/26” is stored in the “BIRTH_DATE” column, and the country “US” is stored in the “COUNTRY” column.

In the input region B in the table C1, rows (records) having an empty (blank) state are arranged between the record (record 1) including the name “Akira”, the date “1910/3/23” and the country “JPN” and the record (record 2) including the name “Stanley”, the date “1928/7/26” and the country “US”. However, these rows having the empty state mean that omission of the record 1. Thus, when identical records are inputted two or more times, input of the identical record after two times is omitted.

In the input region B in the table C2, film names “A”, “B”, “C”, “D” and “E” and years “1943”, “1950”, “1954”, “1962” and “1980” are stored (inputted) in records corresponding to the record 1 in the table C1. Similarly, film names “G”, “H” and “I” and years “1951”, “1962”, “1962” and “1980” are stored (inputted) in records corresponding to the record 2 in the table C1. However, in the table C2, a blank record is disposed between the record including the film name “H” and the year “1968” and the record including the film name “I” and the year “1980”. The blank record means omission of the record including the film name “H” and the year “1968”.

In the input region B in the table C3, a record including a prize name “Award X” and year “1968” and a record including a prize name “Award Y” and year “1969” are stored (inputted). These records are disposed on locations corresponding to the record including the film name “H” stored in the table C2.

As described in FIG. 3B, in the layered table relationship, the table C3 is a table of the lowest layer. Therefore, a blank record under the record including the prize name “Award Y” and the year “1969” means that input data is nothing.

FIG. 3C exemplifies a table based on the RDB system registered by processing of the information processing apparatus 10 of the present embodiment. For example, the table example illustrated in FIG. 3C is a table registration example based on data input in the worksheet exemplified in FIG. 3A. As illustrated in FIG. 3C, data inputted in the tables C1, C2 and C3 in the worksheet exemplified in FIG. 3A is collectively stored in the table based on the RDB system (table example).

In the table example of FIG. 3C, the information indicating the tables C1, C2 and C3 defined in the definition record A1 is stored in a record D1 in order from the left side. Namely, a “DIRECTOR” table corresponding to the table C1 is disposed on the left, a “FILM” table corresponding to the table C2 is disposed on the middle, and a “PRIZE” table corresponding to the table C3 is disposed on the right. Moreover, the information indicating the column items of the tables C1, C2 and C3 defined in the definition record A2 is stored in a record D2. In the column on the left end side of each table, a column item that is a key element defined in the definition record A6 is disposed. For example, the “DIRECTOR_ID” column is disposed on the left end side in the “DIRECTOR” table, the “FILM_ID” column is disposed on the left end side in the “FILM” table, and the “FILM_ID” column is disposed on the left end side in the “PRIZE” table.

Moreover, in the records of the “DIRECTOR” table, record numbers allocated by automatic numbering are stored in the column region corresponding to the “DIRECTOR_ID” column. Similarly, in the “FILM” table, record numbers allocated by automatic numbering are stored in the column region corresponding to the “FILM_ID” column. In the “PRIZE” table, since the relation with the other table (the “FILM” table) is defined with respect to the “FILM_ID” column, record numbers allocated by automatic numbering are stored in the column region corresponding to the “SEQ_NO” column that is adjacent on the right side of the “FILM_ID” column.

In the table example of FIG. 3C, the record numbers allocated by automatic numbering in the “DIRECTOR” table of a relation source are stored in the “DIRECTOR_ID” column of the “FILM” table in which the relation with other table is defined in the definition record A7. For example, in the “DIRECTOR” table, the record number “1” is set to the record including the name “Akira” and the record number “2” is set to the record including the name “Stanley”. The records having the record numbers “1” to “5” in the “FILM_ID” column of the “FILM” table correspond to the record including the name “Akira” in the “DIRECTOR” table. Hence, the record number “1” is set to records of the “DIRECTOR_ID” column corresponding to the records having the record numbers “1” to “5” in the “FILM_ID” column. Therefore, it is understood that the records in which the numbers “1” to “5” are stored in the “FILM_ID” column of the “FILM” table are related with the record of “Akira” in which the number “1” is numbered in the “DIRECTOR_ID” column of the “DIRECTOR” table.

Moreover, for example, the number “2” is stored in the “DIRECTOR_ID” column of the records in which numbers “6” to “9” are stored in the “FILM_ID” column of the “FILM” table. The records in which the numbers “6” to “9” are stored in the “FILM_ID” column of the “FILM” table are associated with the record of “Stanley” in which the number “2” is numbered in the “DIRECTOR_ID” column of the “DIRECTOR” table.

Similarly, record numbers allocated by automatic numbering in an association source table are stored in the “FILM_ID” column of the “PRIZE” table in which the relation with other tables are defined in the definition record A7. For example, record numbers (“1” and “2”) of the “PRIZE” table are stored in the “SEQ_NO” column of the “PRIZE” table. The records having the record numbers “1” and “2” in the “PRIZE” table is allocated the number “8” in the “FILM_ID” column of the “PRIZE” table. Thereby, it is understood that the records having the record numbers “1” and “2” in the “PRIZE” table is related with the record of “H” in which the number “8” is numbered in the “FILM_ID” column of the “FILM” table.

In the information processing apparatus 10 of the present embodiment, for example, the table structure defined in the definition region A of the worksheet is analyzed. In the information processing apparatus 10, based on the analyzed table structure, for example, data inputted in the input region B of the worksheet are collectively registered in a database in a state where the relation between data to extend over multiple tables is maintained. The information processing apparatus 10 of the present embodiment may be collectively registered in the database of data registered in the tables in a state where the consistency between data is secured.

### (DB Update)

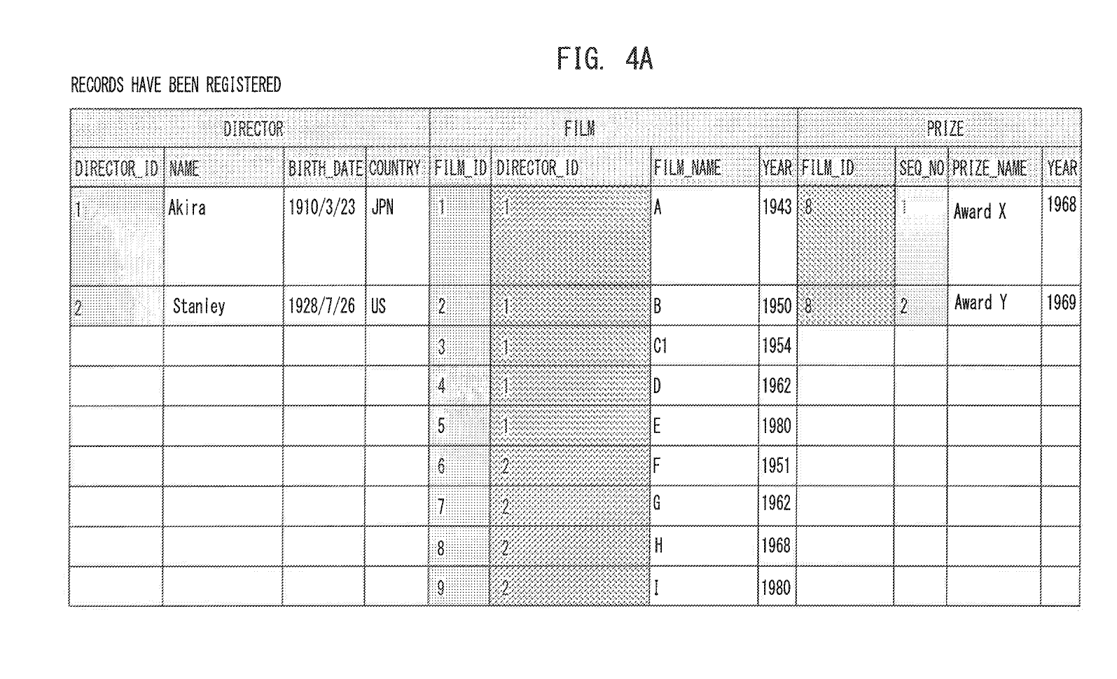

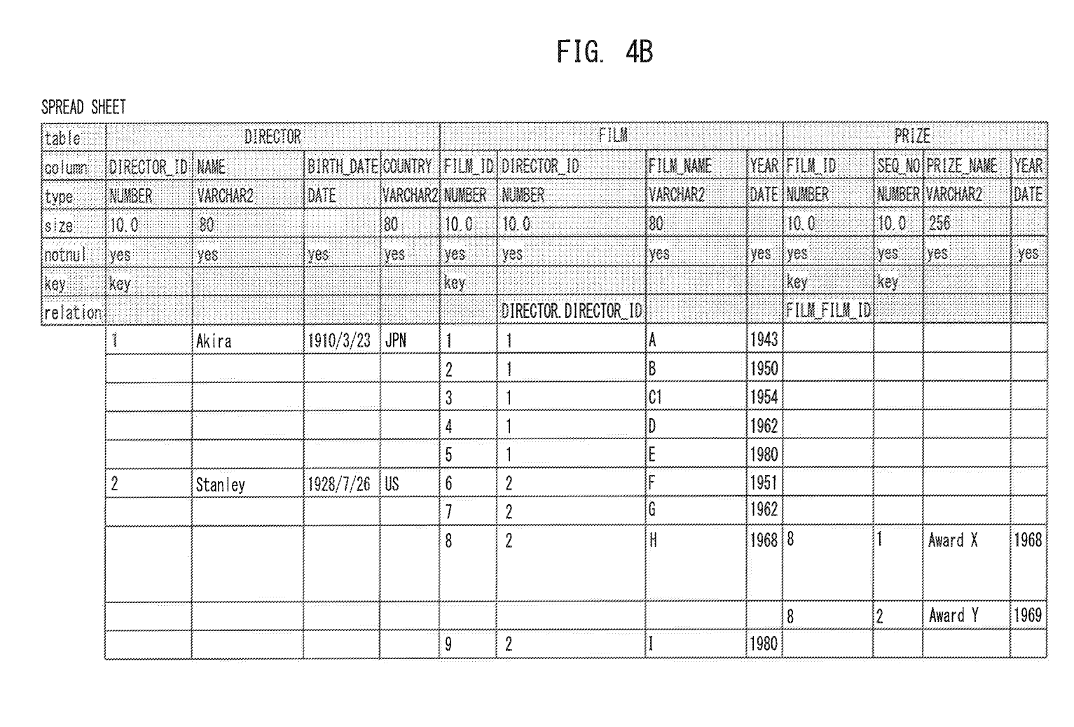

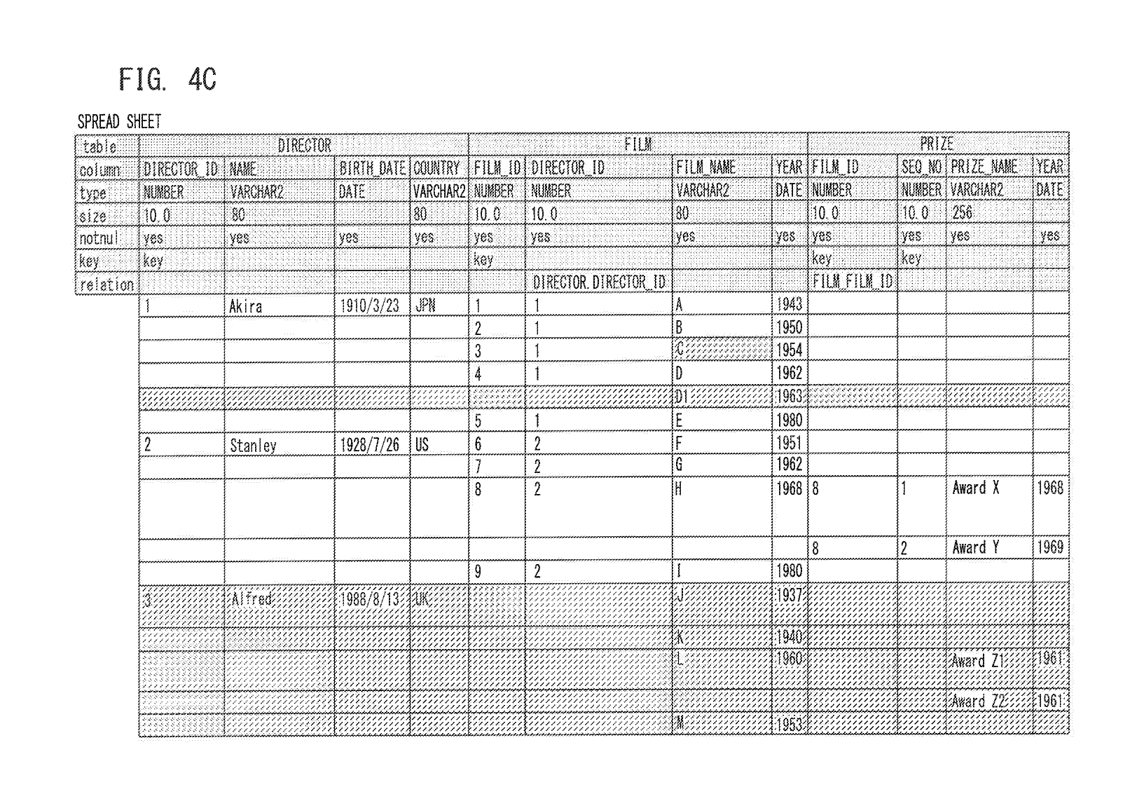

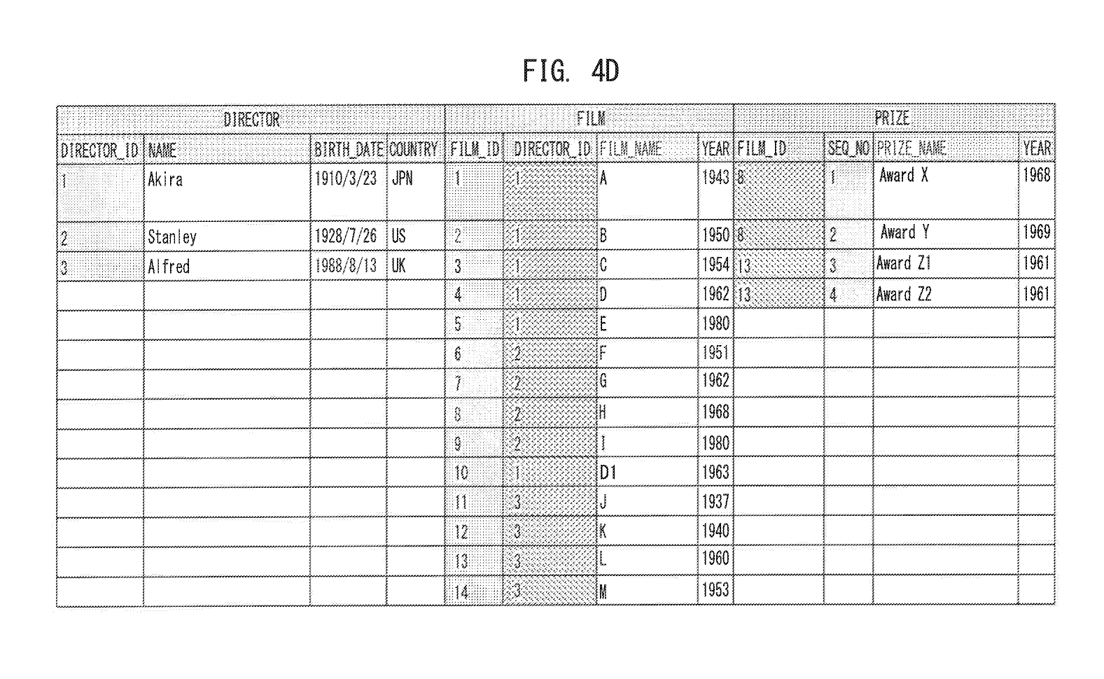

In the information processing apparatus 10 of the present embodiment, by editing a worksheet of collectively registered data, for example, it becomes possible to perform data update with respect to a database that has already been registered. In the following, data update processing with respect to the database that has already been registered is described with reference to FIGS. 4A to 4D.

The table example exemplified in FIG. 4A is the table example described in FIG. 3C. However, in the “FILM” table, a film name “C1” is stored in the “FILM_NAME” column instead of the film name “C”. Moreover, the worksheet example exemplified in FIG. 4B is the worksheet example as described in FIG. 3A. Here, when the worksheet is registered in a database, numbers allocated by automatic numbering are stored in the columns of column items defined as the key element. Further, the numbers automatically numbered at the table of the relation source are stored in the column of column item in which the relation with the other table is defined.

For example, a case is assumed where data addition is caused with respect to the table exemplified in FIG. 4A in which collective registration processing is performed by the information processing apparatus 10. For example, the manager of the information processing apparatus 10 refers to the tables exemplified in FIG. 4A and invokes the worksheet exemplified in FIG. 4B so as to be displayed on a display screen such as the LCD 15a. Further, the manager of the information processing apparatus 10 performs editing work for the worksheet that is displayed on the display screen.

FIG. 4C exemplifies a worksheet example in an editing state. The region (column or record) of an edited part is subjected to hatching by an upper right diagonal. In the example of FIG. 4C, for example, the film name “C1” (see FIGS. 4A and 4B) stored in the “FILM_NAME” column of the “FILM” table is changed into the film name “C”. Moreover, for example, the film name “D1” is added to the “FILM_NAME” column of the “FILM” table. Since a record including the film name “D1” in the “FILM_NAME” column is added between the record including the film name “D” and the record including the film name “E”, numbering is not performed for the columns of “FILM_ID” and “DIRECTOR_ID” in the editing stage.

Moreover, for example, a record related to a movie director of “Alfred” is newly added to the “DIRECTOR” table. Moreover, for example, film names of “J”, “K”, “L” and “M”, each of which relates to the added record of “Alfred”, are added to the “FILM_NAME” column of the “FILM” table. Moreover, prize names of “Award Z1” and “Award Z2” are added to the “PRIZE_NAME” column of the “PRIZE” table. The “Award Z1” and “Award Z2” relate to the film name “L” is stored in the “FILM_NAME” column of the “FILM” table.

For the worksheet in the editing state, for example, the information processing apparatus 10 of the present embodiment analyzes the table structure defined in the definition region A and performs update processing with respect to data added and/or changed, based on the analyzed table structure. Similar to registration processing, the update processing is collectively performed on the database.

FIG. 4D exemplifies a table in which update processing is performed. For example, the table exemplified in FIG. 4D is updated based on the worksheet exemplified in FIG. 4C. In the table example of FIG. 4D, there is no change in the numbering value of the “FILM_ID” column and the “DIRECTOR_ID” column of the “FILM” table with respect to the record in which the film name “C1” is changed into the film name “C”.

Meanwhile, a number “10” newly numbered is stored in the “FILM_ID” column in the record of the film name “D1” added between the record of the film name “D” and the record of the film name “E” in the “FILM_NAME” column of the “FILM” table. Moreover, similarly, the number “1” allocated by automatic numbering with respect to the table of the relation source is stored in a record of the “DIRECTOR_ID” column corresponding to the record of the film name “D1” of the “FILM” table. In the information processing apparatus 10 of the present embodiment, in a case where a new record is added between already inputted records, the number value numbered from an already issued number value is stored in a column region corresponding to a column item defined as a key element. For example, the information processing apparatus 10 of the present embodiment detects an added record position and stores the number value numbered from an already issued number value in a column region corresponding to a column item defined as a key element of the added record.

For example, in the worksheet example exemplified in FIG. 4C, it is assumed that the record including the film name “D1” is added to the record position in which the film name “J” corresponding to the name “Alfred” is stored. In this case, when a column region of the table C1 corresponding to the added record is in a blank state, since it is determined that the same data as “Stanley” overlaps, the number “2” allocated by automatic numbering in a table of a relation source table is stored in the “DIRECTOR_ID” column.

Moreover, for example, it is assumed that information the director name “Akira” is added to the column region corresponding to the table C1 and the record including the film name “D1” is added to the record position in which the film name “J” relating to the director name “Alfred” is stored. In this case, since information is included in the column region corresponding to the table C1, the number allocated in the “DIRECTOR_ID” column is automatically numbered to the newly added record. Therefore, the number “3” is stored. That is, the newly added “Akira” record is treated as a record different from existing “Akira” record in which the number “1” is stored in the “DIRECTOR_ID” column.

In the updated table example exemplified in FIG. 4D, the number “3” is stored in the “DIRECTOR_ID” column of the record of “Alfred” added to the “DIRECTOR” table which is the highest in the layered table structure. It is because numbering with respect to the “DIRECTOR_ID” column is performed in order from an already issued number value in a case where a new record is added.

Further, additionally input data such as “J”, “K”, “L” and “M” is stored in the “FILM_NAME” column of the “FILM” table related to the record of “Alfred”. Moreover, numbers of “11”, “12”, “13” and “14” numbered from already issued number values are sequentially stored in the “FILM_ID” column of the “FILM” table with respect to additionally input of “J”, “K”, “L” and “M”. For example, the reason is that, in the information processing apparatus 10, since update processing is performed on the input region of the worksheet in order from the higher row, the numbering value related to the record of “Alfred” is numbered from the numbering value of “D1” added between existing records.

Moreover, the number “3” allocated by new automatic numbering in an association source table is stored in the “DIRECTOR_ID” column of the “FILM” table related to the record in which the record of “Alfred” is added.

Further, data of “Award Z1” and “Award Z2” is added to the “PRIZE_NAME” column of the “PRIZE” table related to the record in which the record of “Alfred” is added. Moreover, the number “13” allocated by new automatic numbering in the association source table is stored in the “FILM_ID” column of the “PRIZE” table, and the numbers “3” and “4” numbered from already issued number values are stored in the “SEQ_NO” column.

As described in FIGS. 4A to 4D, the information processing apparatus 10 analyzes the table structure defined in the definition region in a worksheet in an editing state and performs update processing with respect to data added and/or changed, based on the analyzed table structure. Therefore, even in the update processing, similar to registration processing, the information processing apparatus 10 may perform collective registration in a database in a state where the relation between data to extend over multiple tables is maintained.

### [Processing Flow]

### [Whole Processing]

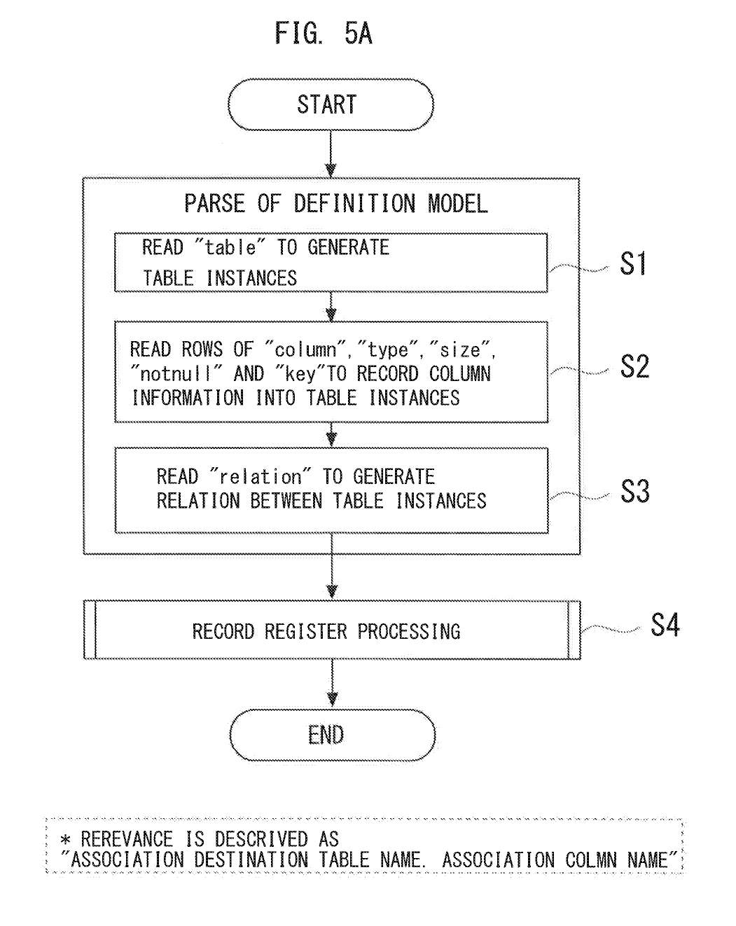

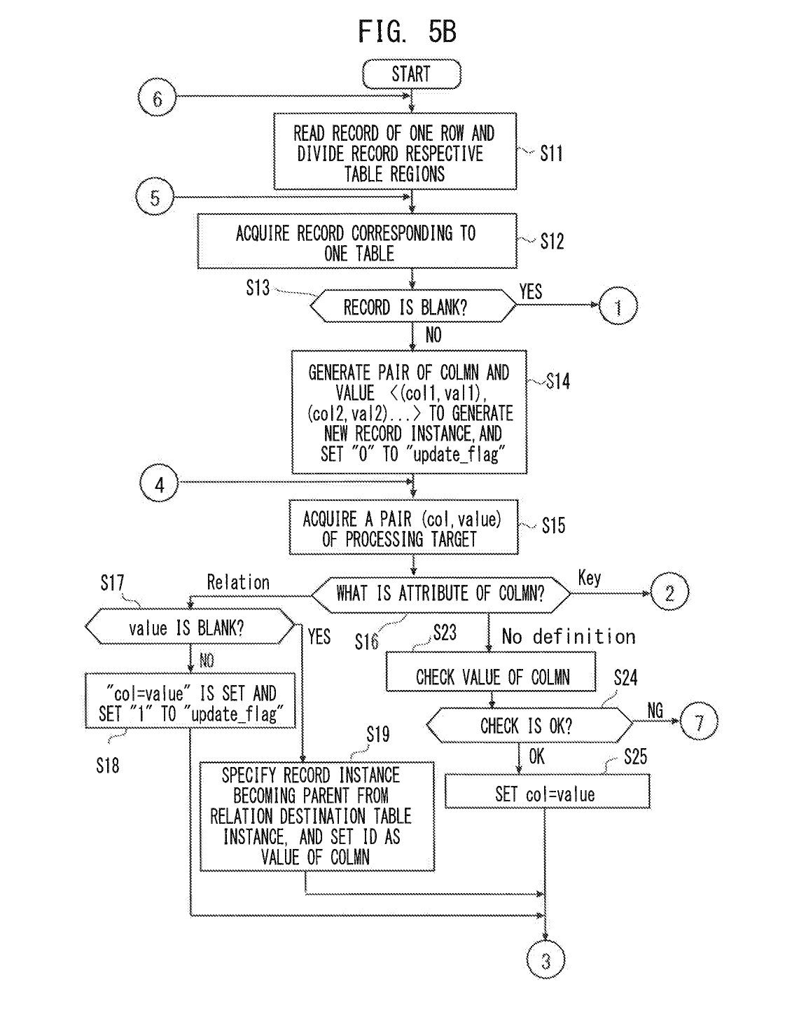

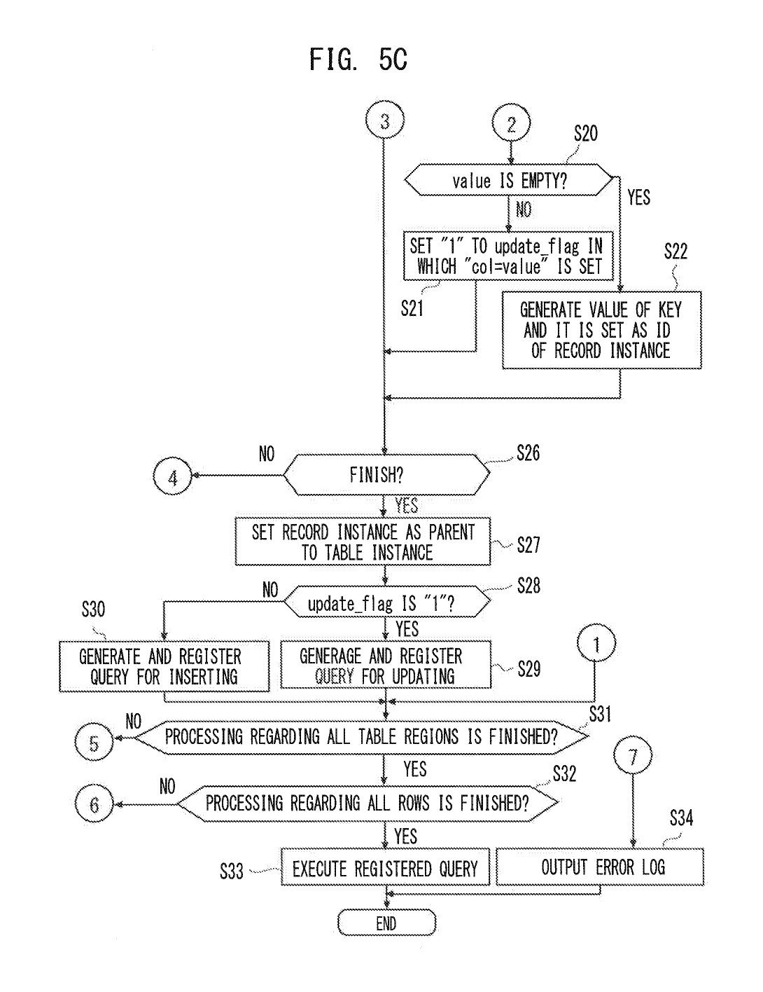

In the following, database registration processing in the information processing apparatus 10 is described with reference to the flowcharts illustrated in FIG. 5A and FIG. 5B. In the database registration processing, the CPU 11 of the information processing apparatus 10 analyzes the table structure defined in the definition region A of the worksheet. The CPU 11 of the information processing apparatus 10 registers data inputted in the input region B of the worksheet for every table based on the analyzed table structure. The input data is registered in tables in a state where the relation between data to extend over multiple tables is maintained.

FIG. 5A is a flowchart illustrating an example of database registration processing. The database registration processing is executed by the CPU 11. In FIG. 5A, for example, the database registration processing is started at appropriate timing such as a start time of the database registration processing. The CPU 11 of the information processing apparatus 10 accepts the worksheet in which data is described in the input region B. The CPU 11 of the information processing apparatus 10 analyzes the definition region A of the accepted worksheet through processing in S1 to S3 and generates internal object (s) of each table in which data is registered. The CPU 11 of the information processing apparatus 10 delivers the internal object generated based on the definition region A of the worksheet to processing in S4.

In the processing in S1, the CPU 11 reads the row of “table” defined by the definition record A1 as illustrated in FIG. 3A to generate table instances such as table type and table region in which data is registered. The generated table instances are temporarily stored in a predetermined area of the main storage device 12 or the auxiliary storage device 13.

In the processing in S2, the CPU 11 reads (specifies) column information (“column”, “type”, “size”, “notnul” and “key”) from the definition records A2 to A6 as exemplified in FIG. 3A to record the column information into each table instance generated in the processing in S1. For example, the column information includes information such as the column items of each table, the data format of each column item, the region size of each column item, information (“notnul” information) indicating whether existence of regions that data is not set is allowed or not, and designation of the key element of each column item. The CPU 11 temporarily stores the table instances in which the specified column information is recorded, in a predetermined region of the main storage device 12 or the auxiliary storage device 13.

In the processing in S3, the CPU 11 specifies the relation between tables for every column item from the definition record A7 as exemplified in FIG. 3A. The CPU 11 generates the relation between table instances based on the specified relation between tables. The CPU 11 reads out the table instances in which the column information is recorded in the processing in S2, and records the generated relation between table instances. The table instances in which the relation between table instances is recorded are temporarily stored in a predetermined region of the main storage device 12 or the auxiliary storage device 13. The table instances in which the relation between table instances is recorded are delivered to the processing in S4.

The processing in S1 to S3 performed by the CPU 11 is one example of process storing a sheet including rows and a definition body, each of the rows including a plurality of elements corresponding to elements of a plurality of tables, and the definition body including key elements in each of the plurality of tables and relation with an element of other tables. Moreover, the CPU 11 or the like of the information processing apparatus 10 performs the processing in S1 to S3 as one example of a storage configured to store a sheet including rows and a definition body, each of the rows including a plurality of elements corresponding to elements of a plurality of tables, and the definition body including key elements in each of the plurality of tables and relation with an element of other tables.

Here, as described in FIG. 3A, in a case where definition of the key element and the relation between tables are defined in an overlapping manner with respect to a column item, the relation between tables is prioritized. Moreover, as described in FIG. 3A, for example, the relation between tables is made by a pair obtained by combining the table name of the relation source table with the column item of the relation source and is described in a form like “ (relation source table) . . . (relation source column item)”.

In the processing in S4,the CPU 11 of the information processing apparatus 10 performs table registration processing of data described in the input region B of the worksheet according to the internal object generated in the processing in S1 to S3. Table registration processing of data described in the input region B of the worksheet is performed in units of records.

### [Registration Processing]

Record registration processing of the input region B in S4 exemplified in FIG. 5A is described with reference to the flowchart exemplified in FIG. 5B and FIG. 5C. In the flowchart exemplified in FIG. 5B and FIG. 5C, the CPU 11 of the information processing apparatus 10 acquires a record of one row from the input region B of the worksheet and divides the region of the acquired record into respective table regions (S11). Each table region divided in the processing in S11 includes the column regions storing data corresponding to the column items of the corresponding table specified in the processing in S2 of the flowchart of FIG. 5A.

The CPU 11 of the information processing apparatus 10 acquires input data of a record region corresponding to one table within the table regions divided in the processing in S11 (S12). The CPU 11 of the information processing apparatus 10 determines whether the record region acquired in the processing in S12 is in a blank state (data is nothing, S13). In the processing in S13, the CPU 11 of the information processing apparatus 10 determines whether or not the table region acquired in the processing in S12 is in an unset state.

In a case where the record region acquired in the processing in S12 is in a blank state (S13, YES), the CPU 11 of the information processing apparatus 10 skips processing in S14 to S30 and proceeds to the processing in S31. On the other hand, in a case where the record region acquired in the processing in S12 is not in a blank state (there is data, S13, NO), the CPU 11 of the information processing apparatus 10 proceeds to the processing in S14.

In the processing in S14, the CPU 11 of the information processing apparatus 10 generates record instances of the table corresponding to the record region acquired in the processing in S12. For example, the record instances generated in the processing in S14 include information defined by the definition record A1 to A6. Moreover, the record instances generated in the processing in S14 include information indicating the relation between tables defined by the definition record A7.

Moreover, in the processing in S14, the CPU 11 of the information processing apparatus 10 generates pair information in which each of the column items of the table corresponding to the record region acquired in the processing in S12 and input data described in each of the column items are combined as a pair. For example, the column item of the table corresponding to the record region acquired in the processing in S12 is defined as “colN” (N is an integer and the number of column items each table), and data described in the column region corresponding to the column items is defined as “valN”. The CPU 11 of the information processing apparatus 10 generates pair information such as {{col1, val1},{col2, val2}, . . . , {colN, valN}} corresponding to the number of column items in the processing in S14.

Moreover, the CPU 11 of the information processing apparatus 10 sets “update_flag” indicating data update registration to “0” in the processing in S14. It is because the worksheet including the definition region A and the input region B as illustrated in FIG. 3A is shared for new registration and update registration of input data.

In the flowchart exemplified in FIG. 5B, the CPU 11 of the information processing apparatus 10 acquires pair information on a processing target from the pair information generated in the processing in S14 (S15). The CPU 11 of the information processing apparatus 10 determines the attribute of the column item of the pair information acquired in the processing in S15 (S16). In the processing in S16, the CPU 11 of the information processing apparatus 10 determines whether the key element is defined and the relation between tables is defined as the column item included in the pair information on the processing target.

For example, in a case where the relation between tables is defined as the attribute of the column item of the pair information acquired in the processing in S15 (S16, “relation”), the CPU 11 of the information processing apparatus 10 performs the processing in S17 to S19. In a case where the key element is defined as the attribute of the column item of the pair information acquired in the processing in S15 (S16, “key”), the CPU 11 of the information processing apparatus 10 performs the processing in S20 to S22. In a case where the relation between tables and the key element are not defined as the attribute of the column item of the pair information acquired in the processing in S15 (S16, “no definition”), the information processing apparatus 10 performs the processing in S23 to S25.

### (Processing of Relation Between Tables)

In the processing in S17, the CPU 11 of the information processing apparatus 10 determines that data of the pair information acquired in the processing in S15 is in a blank state (unset state). In a case where the data of the pair information acquired in the processing in S15 is not in the blank state (S17, NO), the CPU 11 of the information processing apparatus 10 sets the data of the pair information as data corresponding to a column item and sets a value “1” to the “update_flag” (S18). The CPU 11 temporarily stores the processing result in S18 in a predetermined region of the main storage device 12 or the auxiliary storage device 13 and proceeds to the processing in S26.

On the other hand, in a case where the data of the pair information acquired in the processing in S15 is in a blank state (S17, YES), the CPU 11 of the information processing apparatus 10 proceeds to the processing in S19. In the processing in S19, the CPU 11 of the information processing apparatus 10 specifies a record instance that becomes a parent of the relation source table instance. The CPU 11 of the information processing apparatus 10 specifies the record instance becoming the parent based on the relation between tables each column item specified in the processing in S3 of FIG. 5A. Further, the CPU 11 of the information processing apparatus 10 sets an identifier (ID) of the specified record instance as data corresponding to the column item of the pair information. The CPU 11 of information processing apparatus 10 temporarily stores the processing result in S19 in a predetermined region of the main storage device 12 or the auxiliary storage device 13. The processing is proceeded to S26.

### (Processing of Key Element)

In the processing in S20 in FIG. 5C, for example, the information processing apparatus 10 determines that the data of the pair information acquired in the processing in S15 is in a blank column state (unset state). In a case where the data of the pair information acquired in the processing in S15 is not in a blank (empty) state (S20, NO), the CPU 11 of the information processing apparatus 10 sets the data of the pair information as data corresponding to a column item and sets a value “1” to the “update_flag” (S21). The CPU 11 of the information processing apparatus 10 temporarily stores the processing result in S21 in a predetermined region of the main storage device 12 or the auxiliary storage device 13, and proceeds to the processing in S26.

On the other hand, in a case where the data of the pair information acquired in the processing in S15 is in a blank (empty) state (S20, YES), the CPU 11 of the information processing apparatus 10 proceeds to the processing in S22. In the processing in S22, the CPU 11 of the information processing apparatus 10 generates the value of “key” generated by the automatic numbering and sets the generated key value as the identifier (ID) of the record instance generated in S14. Here, in automatic numbering in S22, for example, numbering processing is performed in order from already issued number values. The CPU 11 of the information processing apparatus 10 temporarily stores the processing result in S19 in a predetermined region of the main storage device 12 or the auxiliary storage device 13 and proceeds to the processing in S26.

### (Processing When Key Element and Relation are not Defined)

In the processing in S23, the CPU 11 of the information processing apparatus 10 checks the data of the pair information acquired in the processing in S15. The check is performed by comparing the data format and the region size defined by the column item of the pair information. In a case where the data of the pair information does not suit to the data format and the region size defined by the column item of the pair information (S24, “NG”), the CPU 11 proceeds to the processing in S34 and outputs error information to an error log.

On the other hand, in a case where the data of the pair information suits to the data format and the region size defined by the column item of the pair information (S24, “OK”), the CPU 11 of the information processing apparatus 10 proceeds to the processing in S25. In the processing in S25, the CPU 11 of the information processing apparatus 10 sets the data of the pair information as data corresponding to the column item. The CPU 11 of the information processing apparatus 10 temporarily stores the processing result in S25 in a predetermined region of the main storage device 12 or the auxiliary storage device 13 and proceeds to the processing in S26.

In the processing in S26, the CPU 11 of the information processing apparatus 10 determines whether processing with respect to all column items of the record instance generated in the processing in S14 is finished or not (S26). The CPU 11 of the information processing apparatus 10 determines that there is no target pair information with respect to the pair information generated in the processing in S14. Regarding the pair information generated in the processing in S14, in a case where there is target pair information (S26, NO), the CPU 11 of the information processing apparatus 10 proceeds to the processing in S15 and repeats the processing in S15 to 526.

On the other hand, in a case where there is no target pair information within the pair information generated in the processing in S14 (S26, YES), the CPU 11 of the information processing apparatus 10 proceeds to the processing in S27. In the processing in S27, the CPU 11 of the information processing apparatus 10 sets the record instance generated in the processing in S14, as a parent, regarding the table instance that is a record acquisition target in the processing in S12. The CPU 11 of the information processing apparatus 10 temporarily stores the processing result in S27 in a predetermined region of the main storage device 12 or the auxiliary storage device 13 and proceeds to the processing in S28.

In the processing in S28 to S30, for example, the CPU 11 of the information processing apparatus 10 generates a query for data registration based on the value set to the “update_flag”. In the processing in S28, for example, the CPU 11 of the information processing apparatus 10 determines whether the value set to the “update_flag” is “1” or not.

In a case where the value set to the “update_flag” is “1” (S28, YES), the CPU 11 of the information processing apparatus 10 proceeds to the processing in S29. In S29, the CPU 11 generates an update query for data update and registers the update query in association with the record instance generated in the processing in S14. The CPU 11 of the information processing apparatus 10 temporarily stores the processing result in S29 in a predetermined storage region of the main storage device 12 or the auxiliary storage device, and proceeds the processing to S31.

On the other hand, in a case where the value set to the “update_flag” is “0” (S28, NO), the CPU 11 of the information processing apparatus 10 proceeds to the processing in S30. The CPU 11 of the information processing apparatus 10 generates an insert query for data registration and registers the insert query in association with the record instance generated in the processing in S14. The CPU 11 of the information processing apparatus 10 temporarily stores the processing result in S30 in a predetermined storage region of the main storage device 12 or the auxiliary storage device 13 and proceeds to the processing in S31.

In the processing in S31, regarding the record (row) that is the processing target in the processing in S11, the CPU 11 of the information processing apparatus 10 determines whether processing with respect to all table regions is finished or not (S31). In a case where there is a remaining table region becoming the processing target (S31, NO), the CPU 11 of the information processing apparatus 10 proceeds to the processing in S12 to repeat the processing in S12 to S31. On the other hand, in a case where there is no table region becoming the next processing target (S31, YES), the CPU 11 of the information processing apparatus 10 proceeds to the processing in S32.

In the processing in S32, the CPU 11 of the information processing apparatus 10 determines whether the processing of all rows in the input region B of the worksheet is finished. In a case where the processing of all rows in the input region B of the worksheet is not finished (S32, NO), the CPU 11 of the information processing apparatus 10 proceeds to the processing in S11 to repeat the processing in S11 to S32.

On the other hand, in a case where the processing of all rows in the input region of the worksheet is completed (S32, YES), the CPU 11 of the information processing apparatus 10 proceeds to the processing in S33. In the processing in S33, the CPU 11 of the information processing apparatus 10 collectively executes the update query (or queries) and the insert query (or queries) generated in the processing in S11 to S32. In the processing in S33, the CPU 11 of the information processing apparatus 10 may collectively register and update data inputted in the worksheet to a database in which data management is performed in the RDB system, in a state where the relation between data to extend over tables is maintained.

The processing in S11 to S33 is one example of processing to generates and output the key corresponding to each table and the relation with an element of another table, for each row of the sheet according to the definition body. The CPU 11 may perform the processing in S11 to S33 as an output unit.

The processing in S17 and S18 is one example of processing to determine update registration according to the state of data setting in a region corresponding to the association with the above-mentioned element of the other table in the above-mentioned row. The CPU 11 may perform the processing in S17 and S18 as a determination unit.

Moreover, the processing in S20 and S21 performed by the CPU 11 is one example of processing to determine update registration according to the state of data setting in a region corresponding to above-mentioned key elements of multiple tables, for the above-mentioned rows. The CPU 11 may perform the processing in S20 and S21 as a determination unit.

As described above, the CPU 11 of the information processing apparatus 10 may analyze the table structure defined in the definition region A of a worksheet. The CPU 11 of the information processing apparatus 10 may process table assignment of data inputted in the input region B of the worksheet in units of records including multiple table regions, based on the analyzed table structure. The CPU 11 of the information processing apparatus 10 may collectively register data subjected to table assignment in a database in a state where the relation between data to extend over multiple tables is maintained. Moreover, the CPU 11 of the information processing apparatus 10 may specify a record related to data update from the state of a column region corresponding to a column item in which key elements and the relation between tables are defined. The information processing apparatus 10 may generate an update registration query with respect to the record related to data update. The information processing apparatus 10 may collectively execute data registration queries including the generated update registration query.

As a result, the information processing apparatus 10 may collectively register and update data inputted in the input region B of the worksheet to the database in a state where the relation between data to extend over multiple tables is maintained. In the information processing apparatus 10, it is possible to register and update data to the database while the consistency between data is secured.

### <<Computer-Readable Recording Medium>>

A program that causes a computer or other machines or apparatuses (in the following, a computer, and so on) to achieve either of the above-mentioned functions can be recorded in a recording medium that can be read by a computer, and so on. Further, it is possible to provide the function by causing the computer, and so on, to read and execute the program of this recording medium.

Here, a recording medium that can be read by a computer, and so on, denotes a recording medium that can accumulate information such as data and programs by electrical, magnetic, optical, mechanical or chemical operation, and read it from the computer, and so on. Among such recording media, those that can be removed from the computer, and so on include a flexible disc, a magneto-optical disc, a CD-ROM, a CD-R/W, a DVD, a Blu-ray Disc, a DAT, an 8 mm tape and a memory card such as a flash memory. Moreover, recording media fixed to the computer, and so on include a hard disc and a ROM, and so on.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process comprising:
storing a sheet including rows and a definition body, each of the rows including a plurality of elements corresponding to elements of a plurality of tables, and the definition body including key elements in each of the plurality of tables and relation with an element in other tables; and
generating, with respect to each of the rows, a key corresponding to each of the plurality of tables and relation of a key with the element in other tables based on the definition body.

2. The non-transitory computer-readable recording medium according to claim 1, the process further comprising determining update registration based on a state of data setting in a region of each row, the region corresponding to the relation of the element in other tables.

3. The non-transitory computer-readable recording medium according to claim 1, the process further comprising determining update registration based on a state of data setting in a region of each row, the region corresponding to an element of key of the plurality of tables.

4. A processing method, comprising:
storing, using a processor, a sheet including rows and a definition body, each of the rows including a plurality of elements corresponding to elements of a plurality of tables, and the definition body including key elements in each of the plurality of tables and relation with an element in other tables; and
generating, using the processor, with respect to each of the rows, a key corresponding to each of the plurality of tables and relation of a key with an element in other tables based on the definition body.

5. An information processing apparatus, comprising:
a memory configured to store a sheet including rows and a definition body, each of the rows including a plurality of elements corresponding to elements of a plurality of tables, and the definition body including key elements in each of the plurality of tables and relation with an element in other tables; and
an output unit configured to generate, using the processor, with respect to each of the rows, a key corresponding to each of the plurality of tables and relation of a key with an element in other tables based on the definition body.
